(19) United States
(12) Patent Application Publication
(10) Pub. No.: US 2024/0085648 A1
(43) Pub. Date: Mar. 14, 2024

(54) OPTICAL MODULE

(71) Applicant: SUMITOMO ELECTRIC INDUSTRIES, LTD., Osaka (JP)

(72) Inventor: Hiroshi UEMURA, Osaka (JP)

(21) Appl. No.: 18/461,773

(22) Filed: Sep. 6, 2023

(30) Foreign Application Priority Data
Sep. 14, 2022 (JP) 2022-145985

(51) Int. Cl. G02B 6/42

(52) U.S. Cl. CPC G02B 6/4269; G02B 6/4251; G02B 6/4259; G02B 6/428

(57) ABSTRACT

An optical module according to the present disclosure includes a glass substrate having a first surface, a second surface opposite to the first surface, and a via hole connecting the first surface and the second surface each other; an optical element mounted on the first surface of the glass substrate and joined to the via hole of the glass substrate, the optical element being configured to consume an electricity and perform at least one of an input and an output of an optical signal; a temperature control element mounted on the second surface of the glass substrate and joined to the via hole of the glass substrate, the temperature control element being configured to regulate a temperature of the optical element; and a first housing attached to the first surface, the first housing being configured to hermetically seal the optical element.

### CROSS-REFERENCE TO RELATED APPLICATION

This application claims priority from Japanese Patent Application No. 2022-145985, filed on Sep. 14, 2022, the entire subject matter of which is incorporated herein by reference.

### TECHNICAL FIELD

The present disclosure relates to optical modules.

### BACKGROUND

Japanese Unexamined Patent Publication No. 2021-173875 describes an optical module. The optical module includes a housing having an inner space, optical components accommodated in the inner space of the housing, and a lid sealing the inner space of the housing. The housing is hermetically sealed by closing an opening with the lid. The optical component includes a light source, an optical transmitter circuit, an optical receiver circuit, a high-speed large-scale integration (LSI), a heat sink block, and a Peltier element. The heat sink block is a cooling component that cools the high-speed LSI. The Peltier element is a cooling component that cools the light source, the optical transmitter circuit, and the optical receiver circuit. The Peltier element together with the optical transmitter circuit and the optical receiver circuit is hermetically sealed inside the housing.

Japanese Unexamined Patent Publication No. 2020-086389 describes an optical component. The optical component includes a housing, wiring formed in the housing, an optical circuit element arranged inside the housing, a mount for mounting the optical circuit element, a circuit board, and a lid. The optical components are flip-chip mounted on an external circuit board. The optical circuit element has an optical circuit formed with an optical waveguide. The portion of the optical circuit that performs opto-electric conversion and electro-optic conversion is connected to wiring by a connecting means such as a bonding wire. Since the housing is sealed by the lid, moisture or the like is prevented from entering the housing. Instead of the mount, the temperature control element may be arranged, and in this case, the temperature control element together with the optical circuit is sealed.

“A thermoelectric cooler integrated with IHS on a FC-PBGA package”, Chih-Kuang Yu, Chun-Kai Liu, Ming-Ji Dai, Sheng-Liang Kuo, and Chung-Yen Hsu, 2007 26th International Conference on Thermoelectrics includes a ball grid array (BGA) substrate, a chip mounted on the BGA substrate, a thermoelectric cooler (TEC) mounted on the chip, and a housing accommodating the chip and the TEC. A top surface (circuit surface) of the chip is flip-chip mounted on the BGA substrate. A lower surface (surface of the substrate) of the chip is connected to an integrated heat spreader (IHS) through the TEC. The chip is held from above and below by the BGA substrate and the TEC.

By the way, in order to improve reliability of an optical element, more reliable protection may be required. For example, the optical element may be influenced by the stress due to the temperature changes while hermetically sealed. Therefore, it is required to more reliably protect the hermetically sealed optical element from the influence of the stress and the like.

### SUMMARY

The present disclosure is to provide an optical module that can more reliably protect an optical element and improve reliability of the optical elements.

The optical module according to the present disclosure includes a glass substrate having a first surface, a second surface opposite to the first surface, and a via hole connecting the first surface and the second surface each other; an optical element mounted on the first surface of the glass substrate and joined to the via hole of the glass substrate, the optical element being configured to consume an electricity and perform at least one of an input and an output of an optical signal; a temperature control element mounted on the second surface of the glass substrate and joined to the via hole of the glass substrate, the temperature control element being configured to regulate a temperature of the optical element; and a first housing attached to the first surface, the first housing being configured to hermetically seal the optical element.

### BRIEF DESCRIPTION OF THE DRAWINGS

FIG. 1 is a plan view schematically illustrating an optical module according to an embodiment.

FIG. 2 is a cross-sectional view taken along line II-II in FIG. 1.

FIG. 3 is a cross-sectional view taken along line III-III in FIG. 1.

FIG. 4 is a cross-sectional view illustrating an example of an optical system in the optical module according to the embodiment.

FIG. 5 is a cross-sectional view illustrating an optical module according to Modified Example 1.

FIG. 6 is a cross-sectional view illustrating an optical module according to Modified Example 2.

FIG. 7 is a cross-sectional view illustrating an optical module according to Modified Example 3.

FIG. 8 is a cross-sectional view illustrating an optical module according to Modified Example 4.

FIG. 9 is a plan view schematically illustrating an optical module according to Modified Example 5.

FIG. 10 is a plan view schematically illustrating an optical module according to Modified Example 6.

FIG. 11 is a partially enlarged cross-sectional view of a glass substrate and optical elements of an optical module according to Modified Example 6.

FIG. 12 is a cross-sectional view illustrating an optical module according to Modified Example 7.

FIG. 13 is a cross-sectional view illustrating an optical module according to Modified Example 8.

FIG. 14 is a cross-sectional view illustrating an optical module according to Modified Example 9.

### DETAILED DESCRIPTION

### Description of Embodiment of Present Disclosure

First, embodiments of an optical module according to the present disclosure will be listed and described. An optical module according to one embodiment includes: (1) a glass substrate having a first surface, a second surface opposite to the first surface, and a via hole connecting the first surface and the second surface each other; an optical element mounted on the first surface of the glass substrate and joined to the via hole of the glass substrate, the optical element being configured to consume an electricity and perform at least one of an input and an output of an optical signal; a temperature control element mounted on the second surface of the glass substrate and joined to the via hole of the glass substrate, the temperature control element being configured to regulate a temperature of the optical element; and a first housing attached to the first surface, the first housing being configured to hermetically seal the optical element.

This optical module includes the glass substrate having the first surface, the second surface, and the via hole, the optical element, and the temperature control element. The optical element is mounted on the first surface of the glass substrate. The temperature control element is mounted on the second surface opposite to the first surface. The optical module further includes the first housing connected to the first surface and hermetically sealing the optical element. Therefore, since the optical element mounted on the first surface of the glass substrate is hermetically sealed by the first housing, the optical element can be protected. The glass substrate has a via hole connected between the first surface and the second surface. Therefore, the optical element and the temperature control element can be thermally and firmly connected to each other through the via hole. In this optical module, the optical element is mounted on the opposite side of the temperature control element as viewed from the glass substrate. Therefore, the optical element can be protected from the influence of the stress due to the temperature change by the glass substrate, which has good heat insulation properties. Therefore, the reliability of the optical element can be improved by more reliably protecting the optical element.

(2) In (1) above, the via hole has a thermal conductivity larger than a thermal conductivity of a glass material of the glass substrate. In this case, heat can be more efficiently transferred between the temperature control element and the optical element through the via hole.

(3) In (1) or (2) above, the first surface of the glass substrate has an electrical terminal configured to be connected to an external circuit board for surface mounting of the optical module.

(4) In any one of (1) to (3) above, the optical module may further include a second housing attached to the second surface of the glass substrate and configured to hermetically seal the temperature control element. The second housing includes a heat radiation member thermally coupled to the temperature control element for heat radiation to an outside. In this case, since the temperature control element is hermetically sealed by the second housing, the temperature control element can be protected. The second housing has the heat radiation member. Therefore, the heat of the temperature control element can be radiated through the heat radiation member of the second housing.

(5) In (4) above, the first housing has an inner volume smaller than an inner volume of the second housing. In this case, the volume of the space inside the first housing that accommodates the optical element is smaller than the volume of the space inside the second housing. Therefore, since the volume of the hermetically sealed portion of the optical element is smaller than the volume of the space inside the second housing, the optical element can be more reliably protected from the influence of the stress and the like due to the temperature changes.

An optical module according to one embodiment includes: (9) an optical element configured to consume an electricity and perform at least one of an input and an output of an optical signal; a temperature control element configured to regulate a temperature of the optical element; and a glass substrate sandwiched between the optical element and the temperature control element, the glass substrate including a via hole connected between the optical element and the temperature control element, the via hole having a thermal conductivity larger than a thermal conductivity of a glass material of the glass substrate.

(10) In (9) above, the glass substrate has a first surface, a second surface opposite to the first surface. The optical element is mounted on the first surface and the temperature control element is mounted on the second surface.

(11) In (10) above, the first surface of the glass substrate has an electrical terminal configured to be connected to an external circuit board.

### Details of Embodiment of Present Disclosure

A specific example of an optical module according to an embodiment will be described below with reference to the drawings. It is noted that the present invention is not limited to the following examples, but is intended to include all modifications indicated in the scope of claims and within the scope of equivalents to the scope of claims. In the description of the drawings, the same or corresponding elements are denoted by the same reference numerals, and overlapping descriptions are omitted as appropriate. The drawings may be partially simplified or exaggerated for easier understanding, and dimensional ratios and the like are not limited to those described in the drawings.

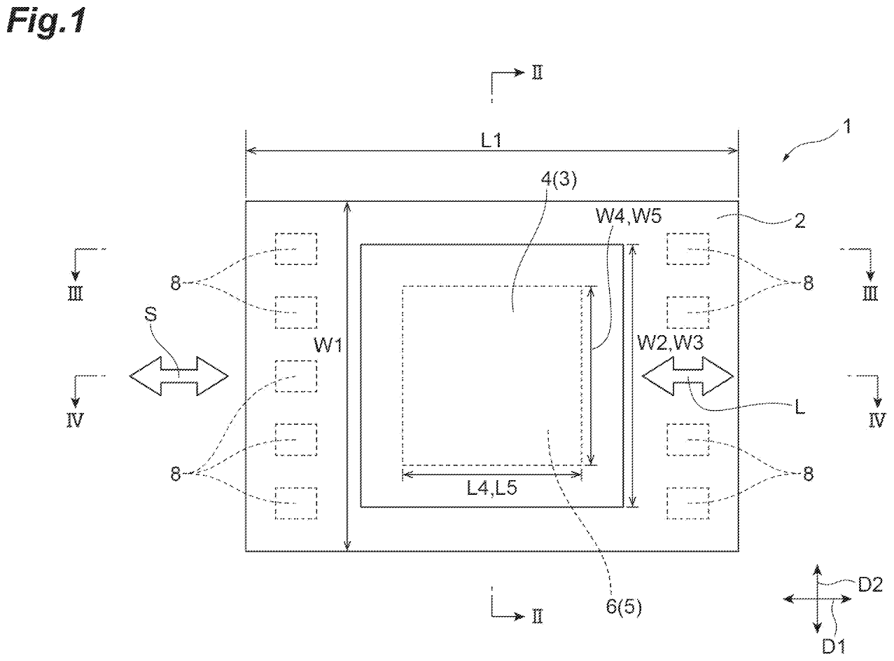

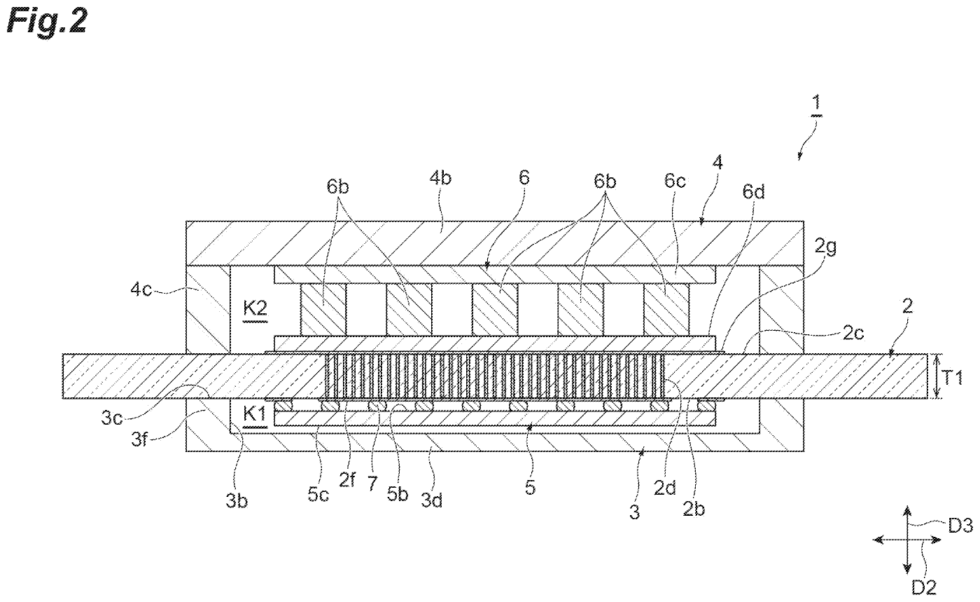

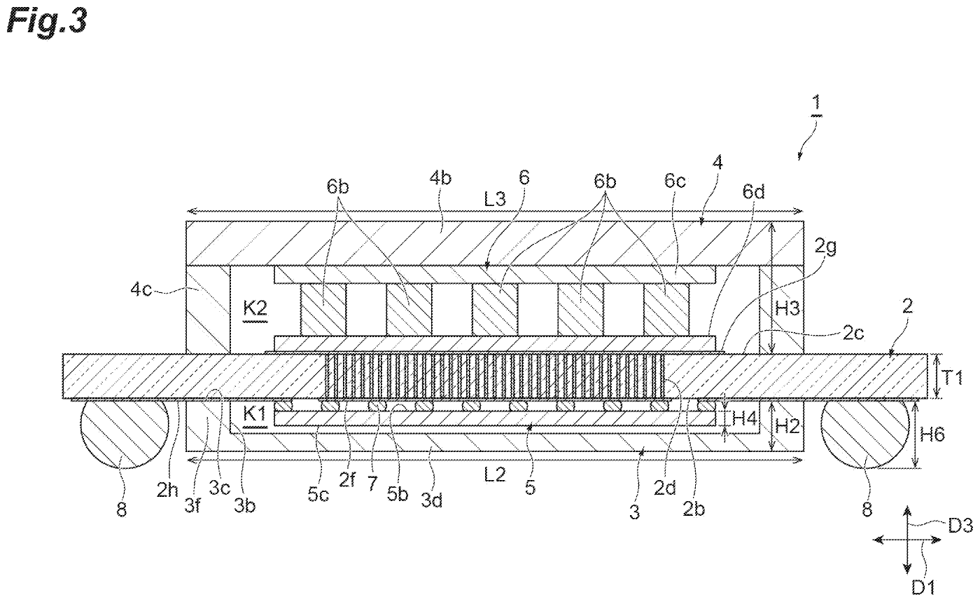

FIG. 1 is a plan view schematically illustrating an optical module 1 according to this embodiment. FIG. 2 is a cross-sectional view taken along line II-II in FIG. 1. FIG. 3 is a cross-sectional view taken along line III-III in FIG. 1. As illustrated in FIGS. 1 to 3, the optical module 1 includes a glass substrate 2, a first housing 3, a second housing 4, an optical element 5, and a temperature control element 6. The glass substrate 2 is made of glass. For example, glass substrate 2 is a glass interposer. The glass substrate 2 extends in a first direction D1 and a second direction D2 intersecting the first direction D1. The glass substrate 2 has a thickness in a third direction D3 intersecting both the first direction D1 and the second direction D2.

As an example, a length L1 of the glass substrate 2 in the first direction D1 is 5 mm, and a length W1 of the glass substrate 2 in the second direction D2 is 5 mm. A length (thickness of the glass substrate 2) T1 of the glass substrate 2 in the third direction D3 is, for example, 0.5 mm. The glass substrate 2 is made of, for example, soda lime glass, borosilicate glass, crystallized glass, or quartz glass. For example, the main component of the glass constituting the glass substrate 2 is silicon dioxide (SiO₂). The glass substrate 2 may be a composition containing at least one of sodium (Na) and calcium (Ca). The linear expansion coefficient of the glass substrate 2 is, for example, 3 to 5 [ppm/K]. However, the linear expansion coefficient of the glass substrate 2 can be reduced to 1 [ppm/K] or less, or about 10 [ppm/K] by adjusting the composition of the materials that constitute the glass. It is desirable that the linear expansion coefficient of the glass substrate 2 has a small difference between the linear expansion coefficient of the optical element 5 and the linear expansion coefficient of a second substrate 6d of the temperature control element 6, which will be described later. Since the difference between the linear expansion coefficients is small, the stress caused by temperature change can be reduced, and reliability of the optical element 5 can be improved. Temperature change causes deformation of parts. The larger the linear expansion coefficient of a part is, the larger the thermal deformation of the part is. Accordingly, temperature change causes the stress between parts bonded to each other depending upon difference between the respective thermal deformations.

The glass substrate 2 has a first surface 2b, a second surface 2c opposite to the first surface 2b, and a via hole 2d connecting the first surface 2b and the second surface 2c. The glass substrate 2 is, for example, a glass substrate having the via hole 2d that is a fine hole, that is, a through glass via (TGV). The via hole 2d is also called as a through via hole. The via hole 2d functions, for example, as a thermal via hole. The via hole 2d has, for example, a cylindrical shape extending along the third direction D3. The diameter of the via hole 2d when viewed along the third direction D3 (in plan view of the glass substrate 2) is, for example, 100 μm. In the cross section of the via hole 2d along the third direction D3, the angle of the boundary line between the via hole 2d and the glass surrounding the via hole 2d is not always perpendicular to the first surface 2b, but may be inclined with respect to the first surface 2b. Therefore, the via hole 2d may extend obliquely in the first direction D1 or the second direction D2 with respect to the first surface 2b.

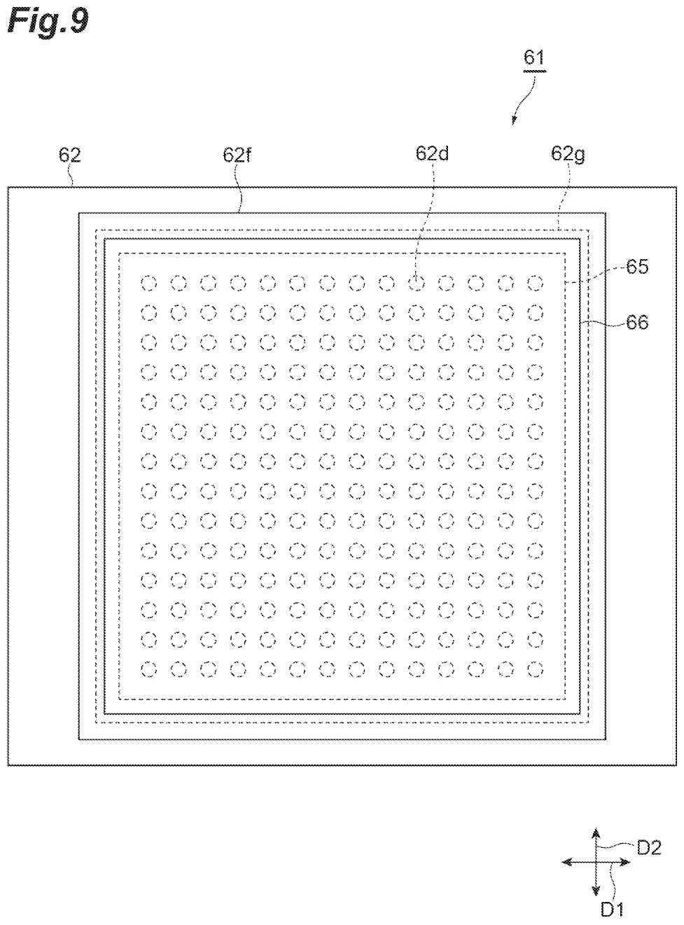

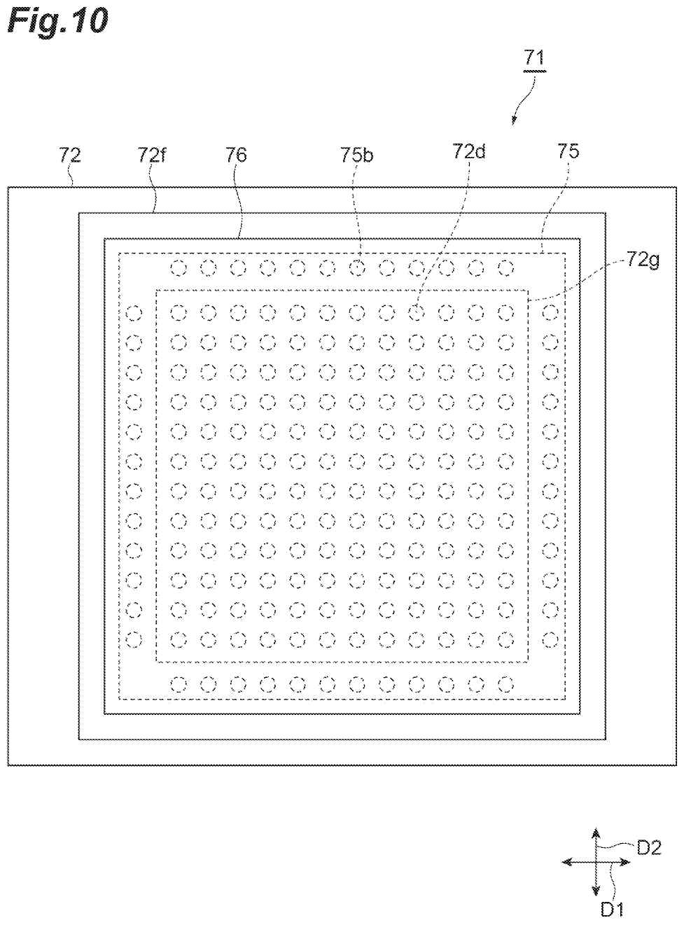

In addition, a shape of the cross section of the via hole 2d perpendicular to the first surface 2b may be tapered or thickened from the first surface 2b to the second surface 2c. Alternatively, the shape may be tapered from the first surface 2b toward the center of the glass substrate 2 in the third direction D3, and then thickened from the center toward the second surface 2c. The diameter of the via hole 2d represents the maximum value of the diameter in the cross section where the cross-sectional shape of the via hole 2d is circular. The glass substrate 2 has a plurality of the via holes 2d. The plurality of via holes 2d are aligned, for example, along each of the first direction D1 and the second direction D2. For example, in plan view of the glass substrate 2, the via holes 2d are two-dimensionally arranged at a constant pitch (refer to FIGS. 9 and 10). The pitch of the via hole 2d (distance from the center axis of one via hole 2d to the center axis of the via hole 2d adjacent to the via hole 2d) is, for example, 250 μm.

The first surface 2b is a surface on which the optical element 5 is mounted, and the second surface 2c is a surface on which the temperature control element 6 is mounted. The first surface 2b extends in both the first direction D1 and the second direction D2. The second surface 2c faces the opposite side of the first surface 2b and extends in both the first direction D1 and the second direction D2. The via hole 2d extends along the third direction D3 from the first surface 2b to the second surface 2c. The via hole 2d is, for example, filled with metal (also called as a filled via hole). As a specific example, the via hole 2d is filled with copper (Cu). The copper filling the via hole 2d adheres to the surrounding glass, so that the airtightness of the glass substrate 2 between the first surface 2b and the second surface 2c is secured. For example, in a fine leak test, the leak amount for the glass substrate 2 in which the via hole 2d is formed is less than 1.0×10⁻⁹ [Pa·m³/s]. Since copper has good thermal conductivity, when the via hole 2d is filled with copper, the via hole 2d can function as a thermal via hole. The via hole 2d is used for at least one of electrical conduction and thermal conduction. The via hole 2d is called as a thermal via hole especially when used for the purpose of heat conduction.

The thermal conductivity of copper (Cu) is about 400 [W/m·K]. Therefore, when the individual area and density of the via hole 2d are adjusted so that an in-plane density (ratio of copper in a plurality of the via holes 2d to the glass portion of the glass substrate 2 when viewed along the third direction D3) of the via hole 2d is 10%, even though the thermal conductivity of the glass portion is estimated to be almost zero, the thermal conductivity of the portion of the via hole 2d (corresponding to the thermal pad described later) is about 40 [W/m·K] on average. The example in which the via hole 2d is made of copper has been described above. However, the via hole 2d may be filled with a semiconductor. As a specific example, the via hole 2d may be filled with silicon (Si).

Since the linear expansion coefficient of Si is about 4 [ppm/K], the linear expansion coefficient of Cu is about 18 [ppm/K], and the linear expansion coefficient of glass is about 3 to 5 [ppm/K], when the via hole 2d is filled with Si, in comparison to the case where the via hole 2d is filled with Cu, the difference in linear expansion coefficient from the glass surrounding the via hole 2d is small. Therefore, the stress caused by temperature change, for example, can be reduced. Reducing the stress allows the via hole 2d to have a larger diameter. For example, in FIGS. 9 and 10, via holes 62d and 72d each having the diameter of 100 lam are aligned along the first direction D1 and the second direction D2 as an example, respectively. However, the via hole 2d may be formed as a single via hole having the same shape and area as thermal pads 2g and 2f, which will be described later. The interior of the single via hole may be filled with Si.

The shape of the single via hole may be rectangular in plan view of the glass substrate 2. The thermal conductivity of Si is about 160 [W/m·K], which is lower than that of Cu, but by increasing the area of the via hole and by increasing the ratio of the total area of the via hole to the area of the glass portion, the thermal conductivity of the portion of the via hole 2d can be improved. For example, the via hole 2d has the higher thermal conductivity than the thermal conductivity of the glass substrate 2 (thermal conductivity of the portion of the glass substrate 2 other than the via hole 2d). The via hole 2d is thermally coupled to the optical element 5 and the temperature control element 6. The via hole 2d conducts heat generated in the optical element 5 to the temperature control element 6 more efficiently than the glass material constituting the glass substrate 2.

The first housing 3 has a cavity 3b, which will be described later, and accommodates the optical element 5 mounted on the first surface 2b of the glass substrate 2 in the cavity 3b. The first housing 3 is made of, for example, glass. In this case, since the material of the first housing 3 is the same as the material of the glass substrate 2, the stress on the optical element 5 due to thermal expansion or thermal contraction can be reduced. However, the first housing 3 may be made of a material other than glass. However, the material of the first housing 3 is preferably a material having airtightness and heat insulation. The first housing 3 is transparent, for example, at a wavelength of an optical signal L input to or output from the optical element 5. The wavelength band of the optical signal L is, as an example, 1.2 μm or more and 1.7 μm or less.

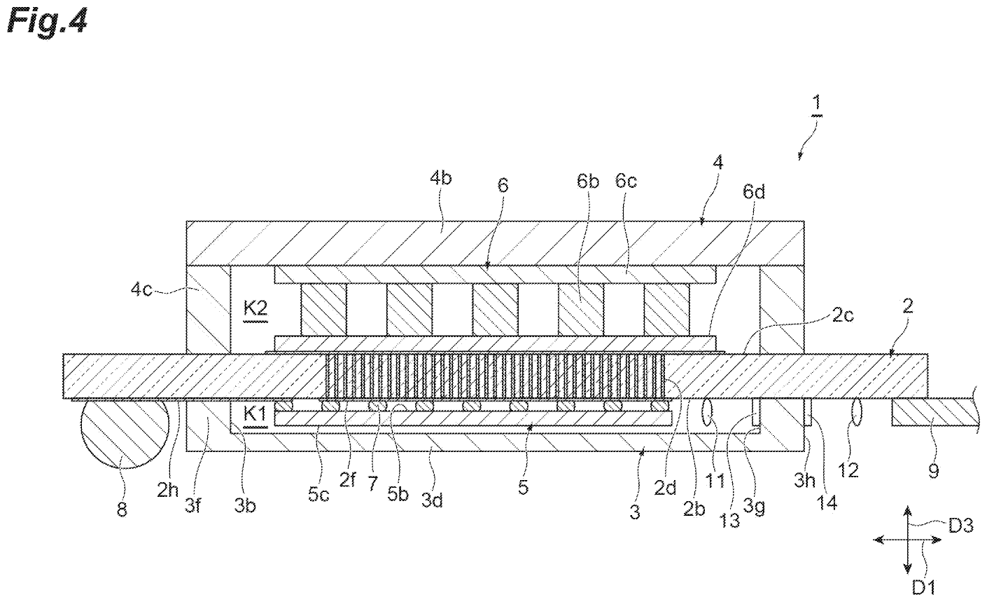

The optical element 5 transmits and receives, for example, an electrical signal S and the optical signal L. FIG. 4 illustrates an example of the optical system for transmitting and receiving the optical signal L in the optical module 1. As illustrated in FIG. 4, the optical module 1 may have the optical fiber 9 positioned outside the first housing 3 (on the side opposite to the optical element 5) when viewed from the third direction D3. As described above, when the first housing 3 is transparent to the wavelength of the optical signal L input to or output from the optical element 5, optical coupling between the optical element 5 and the optical fiber 9 through the first housing 3 is realized. The optical module 1 may include the first lens 11 arranged between the optical element 5 and an inner side surface (inner surface) 3g of the first housing 3 through which the optical signal L is transmitted and the second lens 12 arranged between an outer side surface (outer surface) 3h of the first housing 3 through which the optical signal L is transmitted and the optical fiber 9. Furthermore, the optical module 1 may include at least one of a first anti-reflection coating 13 provided at the position facing the first lens 11 on the inner surface 3g of the first housing 3 and a second anti-reflection coating 14 provided at the position facing the second lens 12 on the outer surface 3h of the first housing 3. In this case, highly efficient optical coupling between the optical element 5 and the optical fiber 9 becomes possible. The first lens 11, the second lens 12, and the optical fiber 9 are positioned by alignment and fixed to the glass substrate 2 using, for example, the adhesive.

As illustrated in FIGS. 2 and 3, for example, the first housing 3 has the cavity 3b recessed in the third direction D3. The first housing 3 may be a housing on which a counterbore is formed as the cavity 3b on the glass plate. A joining surface 3c surrounding the cavity 3b in plan view of the glass substrate 2 is connected to the first surface 2b of the glass substrate 2, and thus, a first airtight space K1 defined by the cavity 3b of the first housing 3 and the first surface 2b of the glass substrate 2 is formed. The optical element 5 mounted on the first surface 2b is accommodated in the first airtight space K1. It is desirable that the difference between the linear expansion coefficient of the first housing 3 and the linear expansion coefficient of the glass substrate 2 is small. Since the difference between the linear expansion coefficients is small, the stress that occurs with the temperature change of the optical module 1 can be reduced. A length L2 of the first housing 3 in the first direction D1 is smaller than the length L1 of the glass substrate 2 in the first direction D1. A length W2 of the first housing 3 in the second direction D2 is smaller than the length W1 of the glass substrate 2 in the second direction D2.

For example, the first housing 3 has a bottom part 3d extending in both the first direction D1 and the second direction D2, and a sidewall part 3f extending from the bottom part 3d in the third direction D3. As an example, the length L2 of the first housing 3 in the first direction D1 is 4 mm, and the length W2 of the first housing 3 in the second direction D2 is 4 mm A height (length in the third direction D3) H2 of the first housing 3 is, for example, 0.3 mm. For example, the bottom part 3d and the sidewall part 3f are portions of a single part (a bulk body). However, the bottom part 3d and the sidewall part 3f may be separate bodies, and the first housing 3 may be configured by bonding the sidewall part 3f to the bottom part 3d. In plan view of the glass substrate 2, the sidewall part 3f has a shape surrounding a periphery of the cavity 3b. That is, the cavity 3b is formed inside the sidewall part 3f. The sidewall part 3f made of glass and optically polished surfaces of the sidewall part 3f, which are the inner surface 3g and the outer surface 3h shown in FIGS. 4, enable an optical coupling through the above-described first housing 3. In this case, the bottom part 3d may be opaque.

The first housing 3 is bonded (sealed) to the glass substrate 2 through, for example, the adhesive (also called as the sealant). This adhesive is made of, for example, metal. As a specific example, the adhesive is made of gold tin (AuSn). In this case, the first housing 3 is bonded to the glass substrate 2 by heating and melting the gold-tin applied to the joining surface 3c. The highly-airtight first airtight space K1 is formed by metal bonding. For example, in the fine leak test, the leak amount for the first airtight space K1 is less than 1.0×10⁻⁹ [Pa·m³/s]. Accordingly, the reliability of the optical element 5 can be further improved. Heat melting is performed, for example, by laser irradiation or heater heating. When the first housing 3 is transparent to a wavelength of the heating laser light, the adhesive can be heated by irradiating with the laser light that transmits through the first housing 3 not from the glass substrate 2 side on which the electrical wiring is formed but from the first housing 3 side. Accordingly, the highly-airtight first airtight space K1 can be formed. For bonding the first housing 3 and the glass substrate 2, solder, glass frit, or epoxy resin may be used as the adhesive. Alternatively, for example, the top surface oxide film (SiO₂) of the first housing 3 and the top surface oxide film of the glass substrate 2 may be directly bonded to each other without using the adhesive. Alternatively, a top surface on which oxide film and metal film are formed may be directly bonded to another top surface on which the oxide film and the metal film are formed (also called as hybrid bonding). When the insulator is used as the adhesive or when the hybrid bonding is performed, the first airtight space K1 is hermetically sealed, and the electrical wiring (feedthrough) connecting the inside of the first airtight space K1 and the outside of the first housing 3 can be formed.

The second housing 4 is connected to the second surface 2c of the glass substrate 2. The second housing 4 accommodates the temperature control element 6 mounted on the second surface 2c of the glass substrate 2. The second housing 4 hermetically seals the temperature control element 6. The second housing 4 has, for example, a heat radiation member 4b extending in both the first direction D1 and the second direction D2 and a sidewall part 4c extending from the heat radiation member 4b in the third direction D3. The heat radiation member 4b has a thermal conductivity higher than that of the glass substrate 2. The heat radiation member 4b has a plate shape. The heat radiation member 4b is made of, for example, silicon (Si). The sidewall part 4c is made of, for example, glass. However, the material of the heat radiation member 4b and the material of the sidewall part 4c are not limited to the above examples. For example, the heat radiation member 4b may be made of metal. In addition, the sidewall part 4c may be made of ceramic. The heat radiation member 4b functions as a heat transfer path located between the temperature control element 6 and the outside of the optical module 1. For example, the heat radiation member 4b is bonded to the sidewall part 4c through the adhesive. For example, in the second housing 4, the heat radiation member 4b made of silicon (Si) and the sidewall part 4c made of glass are integrated with the adhesive. It is desirable that the difference between the linear expansion coefficient of the heat radiation member 4b and the linear expansion coefficient of the glass substrate 2 is small. Since the difference between the linear expansion coefficients is small, the stress caused by the temperature change of the optical module 1 can be reduced.

For example, a length L3 of the second housing 4 in the first direction D1 is smaller than the length L1 of the glass substrate 2 in the first direction D1. A length W3 of the second housing 4 in the second direction D2 is smaller than the length W1 of the glass substrate 2 in the second direction D2. As an example, the length L3 of the second housing 4 in the first direction D1 is 4 mm, and the length W3 of the second housing 4 in the second direction D2 is 4 mm. For example, a height (length in the third direction D3) H3 of the second housing 4 is larger than the height H2 of the first housing 3. As an example, the height H3 of the second housing 4 is 1.5 mm.

The glass substrate 2 and the second housing 4 connected to the glass substrate 2 form a second airtight space K2. The second surface 2c of the glass substrate 2, the sidewall part 4c and the heat radiation member 4b of the second housing 4 define the second airtight space K2. For example, the volume of the first airtight space K1 of the first housing 3 is smaller than the volume of the second airtight space K2 of the second housing 4. For example, the first airtight space K1 is more airtight than the second airtight space K2. That is, for example, the leak amount in hermetic sealing by the first housing 3 is smaller than the leak amount in hermetic sealing by the second housing 4. The second housing 4 is bonded to the glass substrate 2 through, for example, the adhesive. As an example, the first housing 3 is bonded to the glass substrate 2 through gold tin (AuSn), and the second housing 4 is bonded to the glass substrate 2 through resin. For example, the second housing 4 is bonded to the glass substrate 2 through ultraviolet curable resin. In this case, the second airtight space K2 can be less airtight than the first airtight space K1. However, the airtightness of the second airtight space K2 may be lower than the airtightness of the first airtight space K1. As an example, in the fine leak test, the leak amount for the second airtight space K2 may be less than 1.0×10⁻⁹ [Pa·m³/s]. In this case, dew condensation on the temperature control element 6 accommodated in the second airtight space K2 can be suppressed, and the reliability of the temperature control element 6 can be improved.

For bonding the second housing 4 and the glass substrate 2, solder, glass frit, or epoxy resin may be used as the adhesive. Alternatively, for example, the top surface oxide film (SiO₂) on the bonding surface of the sidewall part 4c and the top surface oxide film on the second surface 2c of the glass substrate 2 may be directly bonded without using the adhesive, or one of the top surfaces on which oxide film and metal film are formed may be bonded to the other of the top surfaces on which the oxide film and the metal film are formed by hybrid bonding. When the insulator is used as the adhesive or when the hybrid bonding is performed, the second airtight space K2 is hermetically sealed, and electrical wirings of connecting the inside of the second airtight space K2 and the outside of the second housing 4 can be formed. It is noted that a hygroscopic material adsorbing moisture or a decomposition agent decomposing moisture may be arranged in the second airtight space K2. In the second airtight space K2, the top surfaces of the glass substrate 2, the second housing 4, and the temperature control element 6 may be protected (coated) with the insulating film such as resin even when dew condensation occurs, moisture does not penetrate inside.

As an example, the optical element 5 is an optical modulator. The optical element 5 is made of, for example, indium phosphide (InP). In this case, the linear expansion coefficient of the optical element 5 is about 4.6 [ppm/K]. As an example, a length L4 of the optical element 5 in the first direction D1 is 3 mm, and a length W4 of the optical element 5 in the second direction D2 is 3 mm A height (length in the third direction D3) H4 of the optical element 5 is, for example, 0.1 mm. The optical element 5 is flip-chip mounted (or face-down mounted) so that a circuit surface (first surface) 5b for the glass substrate 2 faces the glass substrate 2 in the first airtight space K1. This flip-chip mounting uses, for example, thermocompression bonding or ultrasonic bonding.

It is noted that the optical element 5 may be an optical element other than the optical modulator. For example, the optical element 5 may be a semiconductor laser or a photodiode. For example, the optical element 5 has the first surface 5b (circuit surface) facing the glass substrate 2 and a second surface 5c (surface of the substrate) facing away from the first surface 5b. The circuit surface is a surface on which optical circuit components such as optical waveguides, optical splitters, and optical couplers are formed on the substrate of the optical element 5. The epitaxial layer may be formed on the circuit surface and active elements may be formed thereon. The surface of the substrate is usually not formed with optical circuit components. However, passive elements such as electrodes or lenses may be formed on the surface of the substrate. For example, the optical element 5 has electrodes (pads) formed on the first surface 5b, and the electrodes are electrically and thermally coupled to the electrodes 2f and the via hole 2d formed on the first surface 2b of the glass substrate 2 through bumps 7. For example, the electrodes formed on the first surface 5b may be pads made of gold (Au). As an example, the bumps 7 are Au stud bumps. An underfill resin may be filled between the glass substrate 2 and the optical element 5.

For example, since the side of the optical element 5 opposite to the glass substrate 2 (side of the second surface 5c) is surrounded by gas, the side is thermally floating. On the other hand, the optical element 5 is thermally and firmly connected to the temperature control element 6 through the via hole 2d of the glass substrate 2. Therefore, the optical element 5 is less susceptible to heat from the first housing 3 and is efficiently temperature-controlled by the temperature control element 6. For example, the thermal resistance between the optical element 5 and the temperature control element 6 is one order of magnitude lower than the thermal resistance between the optical element 5 and the first housing 3. In the state where the second housing 4 is bonded to the glass substrate 2, the heat radiation member 4b is positioned on the side opposite to the second surface 2c when viewed from the temperature control element 6. Therefore, the temperature control element 6 is interposed between the heat radiation member 4b and the glass substrate 2. The temperature control element 6 is thermally and firmly connected to the heat radiation member 4b. The temperature control element 6 is, for example, a thermoelectric cooler. For example, the temperature control element 6 has a plurality of Peltier elements 6b, and a first substrate 6c and a second substrate 6d interposing a plurality of the Peltier elements 6b in the third direction D3. The first substrate 6c and the second substrate 6d are, for example, ceramic substrates. The first substrate 6c is in contact with the heat radiation member 4b. The second substrate 6d is connected to the via hole 2d through the electrode 2g formed on the second surface 2c of the glass substrate 2.

It is noted that electric power can be supplied to the temperature control element 6 by forming the electrode different from the electrode 2g on the second surface 2c of the glass substrate 2 and electrically connecting, for example, wire bonding to the electrical terminal of the temperature control element 6. In addition, for example, the thermistor is arranged on the second surface 2c of the glass substrate 2, so that this thermistor can be used as the monitor for temperature measurement. The circuit surface of the optical element 5 is fixed to the glass substrate 2 and physically connected to the temperature control element 6. In contrast, the surface of the substrate of the optical element 5 is not in contact with other components. Therefore, in comparison to the configuration in which both the circuit surface and the surface of the substrate are fixed, the influence of the stress and the like on the optical element 5 due to the temperature changes can be suppressed. More specifically, when the optical element 5 is interposed between the temperature control element 6 and the glass substrate 2 in the second airtight space K2 (when the optical element 5 is mounted on the glass substrate 2, and the temperature control element 6 is mounted on the surface of the substrate of the optical element 5 so that the circuit surface faces the second surface 2c of the glass substrate 2), since the second housing 4, the temperature control element 6, the optical element 5, and the glass substrate 2 expand or contract together with the temperature change according to their respective linear expansion coefficients, the large stress may be likely to be applied to the optical element 5. However, in this embodiment, since only one of the circuit surface and the surface of the substrate of the optical element 5 is fixed, the thermal stress applied to the optical element 5 can be reduced. This improves the reliability of the optical element 5.

The electrodes 2f and 2g of the glass substrate 2 are formed by plating the top surface of, for example, copper (Cu) with gold (Au). The electrodes 2f and 2g may be formed by plating, for example, nickel (Ni) or palladium (Pd) between gold plating and copper. The electrodes 2f and 2g may be pads (thermal pads) covering a plurality of the via holes 2d. That is, the electrodes 2f and 2g may be thermal pads including the via hole 2d in plan view of the glass substrate 2. This thermal pad is a thin film made of, for example, copper. The thermal interface material (TIM) may be interposed between the first substrate 6c and the heat radiation member 4b or between the second substrate 6d and the electrode 2g. This thermally conductive material is made of, for example, metal paste, solder, or resin. As an example, a length L5 of the temperature control element 6 in the first direction D1 is 3 mm, and a length W5 of the temperature control element 6 in the second direction D2 is 3 mm. For example, a height of the temperature control element 6 (length in the third direction D3) is 1 mm.

For example, the optical module 1 has an electrical terminal 8 for external connection. The electrical terminal 8 is an electrical terminal for top surface mounting provided on the first surface 2b of the glass substrate 2. The surface of the glass substrate 2 on which the electrical terminal 8 for top surface mounting is provided is also called as a surface mounting side. A height (length in the third direction D3) H6 of the electrical terminal 8 with respect to the first surface 2b is larger than the height H2 of the first housing 3 with respect to the first surface 2b. As an example, the electrical terminal 8 is a spherical solder ball. The diameter of the electrical terminal 8 is, for example, 400 μm. The electrical terminal 8 is, for example, an Sn—Ag—Cu alloy solder. The electrical terminal 8 is connected to an electrical wiring 2h formed on the first surface 2b of the glass substrate 2. The top surface of the electrical wiring 2h may be protected with a passivation film. In that case, the electrode (pad) with exposed metal is formed in a portion of the electrical wiring 2h connected to the electrical terminal 8. The electrodes may have top surfaces plated with an under-bump metal. The electrical wiring 2h is electrically connected to electrodes formed on the first surface 5b of the optical element 5 through the bump 7. The optical module 1 has a plurality of the electrical terminals 8, and a plurality of the electrical terminals 8 are arranged, for example, to be aligned along the second direction D2. It is noted that the electrical terminals 8 may be arranged in an array. For example, a plurality of the electrical terminals 8 constitute a ball grid array (BGA).

Next, the functions and effects obtained from the optical module 1 according to this embodiment will be described. The optical module 1 includes the glass substrate 2 having the first surface 2b, the second surface 2c, and the via hole 2d, the optical element 5, and the temperature control element 6. The optical element 5 is mounted on the first surface 2b of the glass substrate 2. The temperature control element 6 is mounted on the second surface 2c opposite to the first surface 2b. Furthermore, the optical module 1 includes the first housing 3 that is connected to the first surface 2b and hermetically seals the optical element 5. Therefore, since the optical element 5 mounted on the first surface 2b of the glass substrate 2 is hermetically sealed by the first housing 3, the optical element 5 can be protected by hermetic sealing. The glass substrate 2 has the via hole 2d connecting the first surface 2b and the second surface 2c. Therefore, the optical element 5 and the temperature control element 6 can be thermally and firmly connected to each other through the via hole 2d. The surface of the optical element 5 opposite to the surface connected to the via hole 2d has a low thermal conductivity. In the optical module 1, the optical element 5 is mounted on the opposite side of the temperature control element 6 when viewed from the glass substrate 2. Therefore, the optical element 5 can be protected from the influence of the stress due to the temperature change by the glass substrate 2 having good heat insulation properties. Therefore, the reliability of the optical element 5 can be improved by protecting the optical element 5 more reliably.

In this embodiment, the via hole 2d has a thermal conductivity larger than that of the glass portion of the glass substrate 2. Therefore, heat can be transferred more efficiently between the temperature control element 6 and the optical element 5 through the via hole 2d. Therefore, the temperature control element 6 can efficiently control the temperature of the optical element 5.

In this embodiment, the first surface 2b is provided with the electrical terminal 8 for top surface mounting. Furthermore, in this embodiment, the optical module 1 further includes the second housing 4 connected to the second surface 2c and having the heat radiation member 4b opposite to the second surface 2c. The second housing 4 hermetically seals the temperature control element 6. The temperature control element 6 is thermally coupled to the heat radiation member 4b. Therefore, since the temperature control element 6 is hermetically sealed by the second housing 4, the temperature control element 6 can be protected from condensation and the like. The second housing 4 has the heat radiation member 4b. Therefore, the heat of the temperature control element 6 can be radiated through the heat radiation member 4b of the second housing 4.

In this embodiment, the volume inside the first housing 3 is smaller than the volume inside the second housing 4. That is, the volume of the space inside the first housing 3 in which the optical element 5 is accommodated is smaller than the volume of the space inside the second housing 4. Therefore, since the volume of the hermetically sealed portion of the optical element 5 is smaller than the volume of the space inside the second housing 4, the optical element 5 can be more reliably protected from the influence of the stress and the like due to the temperature changes. Furthermore, the optical module 1 according to this embodiment does not include the temperature control element 6 in the first airtight space K1. That is, in the optical module 1, the optical element 5 is hermetically sealed separately from the temperature control element 6 in the first airtight space K1. Therefore, since the outflow of gas from the first airtight space K1 can be more reliably suppressed, the reliability of the optical element 5 is further improved. More specifically, when the optical element is accommodated in the same space as the temperature control element or other component, the optical element may be likely to be influenced by outgassing from the temperature control element or the other component. However, in this embodiment, the optical element 5 is hermetically sealed alone. Therefore, the reliability of the optical element 5 is further improved.

It is noted that in the present embodiment, only the optical element 5 is accommodated in the first airtight space K1. However, the first airtight space K1 may accommodate a circuit chip such as an IC for driving, for example, the optical element 5. When the optical element 5 and the circuit chip are accommodated in the first airtight space K1, the lengths L2, W2, and the height H2 of the first housing 3 can be changed as appropriate. The circuit chip has, for example, the same length and thickness as the optical element 5 and has the smaller volume than the temperature control element 6. For example, the thickness of this circuit chip is 0.2 to 0.3 mm, which is smaller than the thickness of the temperature control element 6 (for example, 1 mm) For this reason, the volume of the first airtight space K1, which is a hermetically sealed portion inside the first housing 3, can be allowed to be smaller than the volume of the second airtight space K2, and the influence of the stress and the like on the optical element 5 due to the temperature changes can be suppressed.

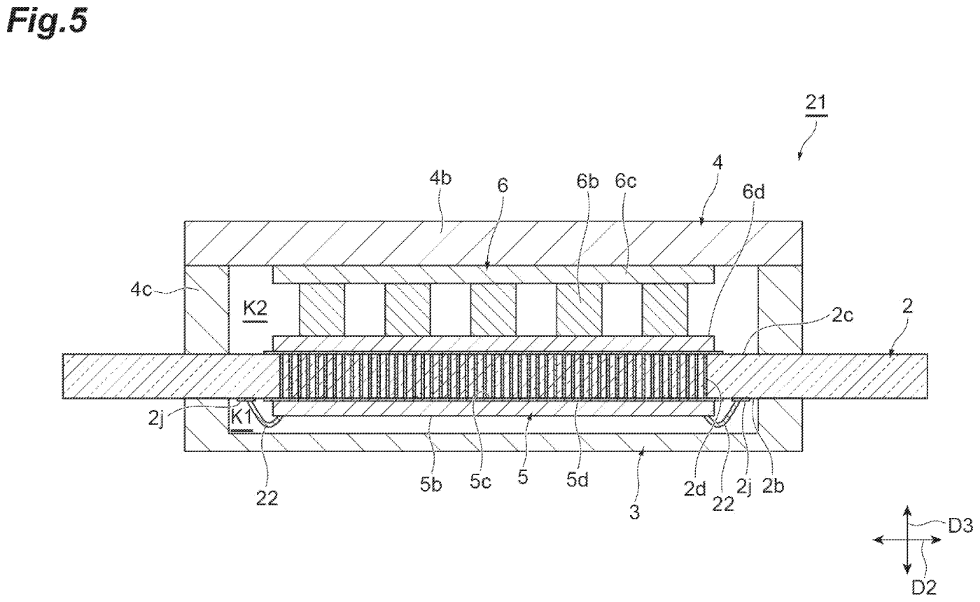

Next, optical modules according to various modifications will be described. A portion of the configuration of the optical module according to modifications described later is the same as a portion of the configuration of the optical module 1 described above. Therefore, in the following description, description overlapping with the description of the optical module 1 will be omitted as appropriate. FIG. 5 is a cross-sectional view illustrating an optical module 21 according to Modified Example 1. In the above embodiment, the face-down mounting (flip-chip mounting) has been described, in which the optical element 5 has electrodes formed on the first surface 5b and the electrodes are thermally coupled to the via hole 2d of the glass substrate 2. On the other hand, in the optical module 21, the optical element 5 is mounted face-up on the glass substrate 2 so that the first surface 5b faces the side opposite to the via hole 2d of the glass substrate 2.

The first surface 5b of the optical element 5 is a circuit surface on which electrodes and circuits are formed, and the second surface 5c of the optical element 5 opposite to the circuit surface is a surface of the substrate. In the face-up mounting, the second surface 5c of the optical element 5 is connected to the first surface 2b of the glass substrate 2. For example, a thermal pad 5d is formed on the first surface 2b of the glass substrate 2 so as to cover a plurality of the via holes 2d, and the second surface 5c of the optical element 5 is connected to the thermal pad 5d through the adhesive (for example, silver paste). Electrodes (pads) are formed on the first surface 5b of the optical element 5 for connection with circuits outside the optical element 5, and the electrodes formed on the first surface 5b are electrically connected to electrical wirings 2j formed on the first surface 2b of the glass substrate 2 through the bonding wire 22. The bonding wire 22 extends from the electrode on the first surface 5b to the electrical wiring 2j. As described above, in the face-up mounting of the optical module 21, for example, the entire second surface 5c of the optical element 5 is connected to the first surface 2b, and thus, in comparison to the flip-chip mounting case, for the same chip size of the optical element 5, the large area can be secured for the portion connected to the thermal pad 5d. In addition, there is no need to use the bumps 7 between the optical element 5 and the glass substrate 2. As a result, the thermal resistance between the optical element 5 and the temperature control element 6 can be allowed to be smaller.

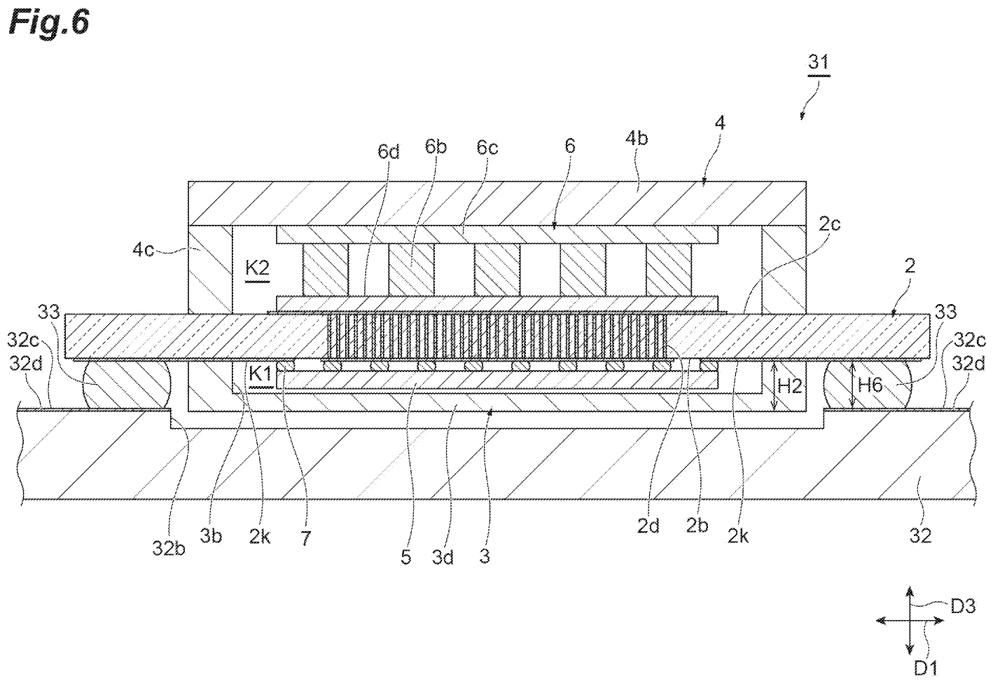

Next, an optical module 31 according to Modified Example 2 will be described with reference to FIG. 6. As illustrated in FIG. 6, the optical module 31 is top-surface-mounted on an external circuit board 32. The optical module 31 has an electrical terminal 33 interposed between the glass substrate 2 and the circuit board 32. The circuit board 32 has a cavity 32b facing the first surface 2b of the glass substrate 2 and the first housing 3. The cavity 32b is recessed in the third direction D3 from a top surface 32d of the circuit board 32 on which an electrical wiring 32c is formed. The glass substrate 2 has an electrical wiring 2k formed on the first surface 2b and extending from the bump 7 to the outside of the first housing 3 when viewed from the third direction D3. The electrical terminal 33 electrically connects the electrical wiring 2k and the electrical wiring 32c of the circuit board 32 to each other. The top surface of the electrical wiring 32c may be protected with a passivation film. In that case, the metal is exposed from the passivation film to form the electrode on the portion of the electrical wiring 32c where the electrical terminal 33 is mounted. The top surface of this electrode may be plated with, for example, Au.

For example, when the height H2 (length in the third direction D3) of the first housing 3 is higher than the height H6 of the electrical terminal 33, a portion of the first housing 3 enters the cavity 32b. It is noted that the height H6 of the electrical terminal 33 at this time corresponds to the distance between the glass substrate 2 and the circuit board 32 when the glass substrate 2 and the circuit board 32 are connected by the electrical terminal 33. As a result, when the optical module 31 is top-surface-mounted on the circuit board 32, interference between the optical module 31 and the circuit board 32 can be prevented, and mounting can be performed more reliably, so that reliability is improved. It is noted that the optical module 31 may have heat radiation fins on the heat radiation member 4b of the second housing 4. Moreover, the optical module 31 may further include an air cooling fan for efficiently radiating heat from the heat radiation fins.

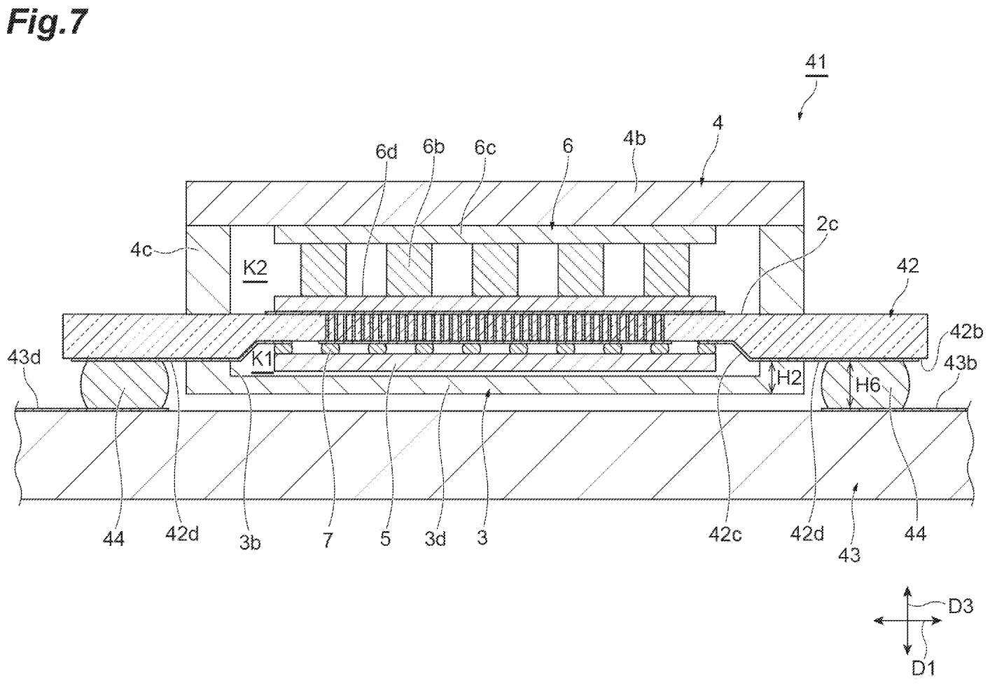

An optical module 41 according to Modified Example 3 will be described with reference to FIG. 7. As illustrated in FIG. 7, the optical module 41 is top-surface-mounted on a circuit board 43, similarly to the optical module 31 described above. However, the circuit board 43 does not have the cavity 32b described above, and a cavity 42c is formed in a first surface 42b of a glass substrate 42. The bottom surface of the cavity 42c and the circuit surface of the optical element 5 face each other. Accordingly, the height of the first housing 3 with respect to the first surface 42b can be suppressed to be low. The optical module 41 has an electrical terminal 44 interposed between the glass substrate 42 and the circuit board 43.

The height H6 (length in the third direction D3) of the electrical terminal 44 is larger than the height H2 of the first housing 3. Therefore, the first housing 3 can be prevented from being in contact with the circuit board 43. That is, the appropriate space can be provided between the first housing 3 and the circuit board 43 in the third direction D3. Since Modified Example 3 can suppress the height H2 of the first housing 3 to be lower than Modified Example 2, the optical module 41 can be easily mounted without providing the cavity in the circuit board 43. The cavity 42c is formed in the first surface 42b by, for example, cutting or etching. The cavity 42c is recessed in the third direction D3 on the first surface 42b. The glass substrate 42 has an electrical wiring 42d formed on the first surface 42b and extending from the bump 7 to the outside of the first housing 3. The electrical wiring 42d can electrically connect the bottom surface of the cavity 42c with different heights to the first surface 42b on which the electrical terminal 44 is formed. In order to facilitate the formation of the electrical wiring 42d, it is desirable that the sidewall of the cavity 42c be inclined with respect to the first surface 42b. The angle of this inclination is, for example, 45° with respect to the bottom surface of the cavity 42c. The electrical terminal 44 electrically connects the electrical wiring 42d and an electrical wiring 43b of the circuit board 43 to each other.

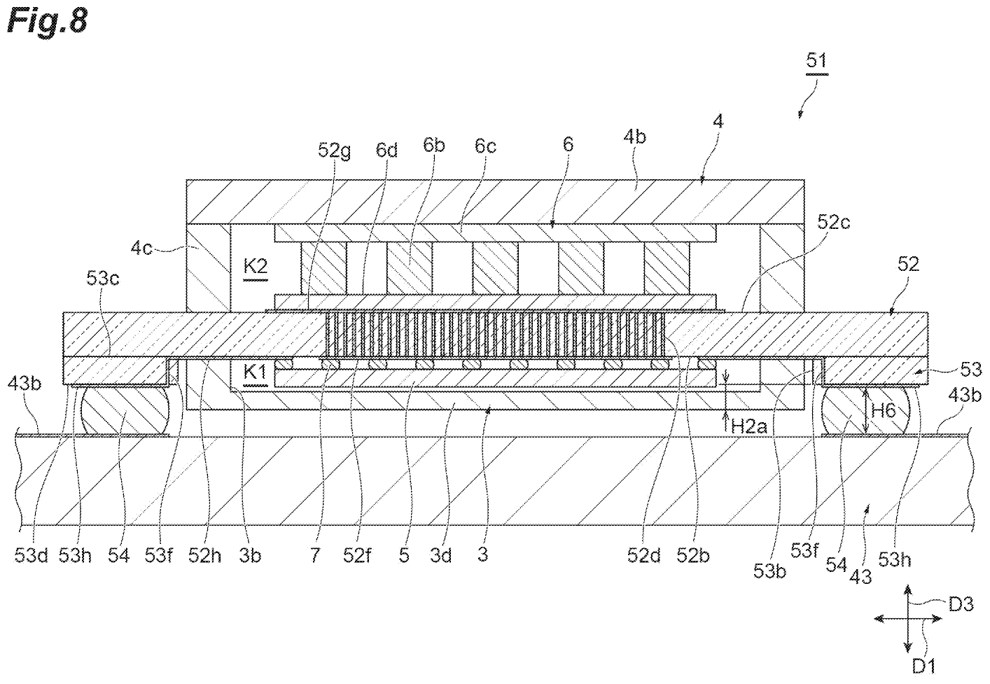

An optical module 51 according to Modified Example 4 will be described with reference to FIG. 8. As illustrated in FIG. 8, the optical module 51 has a first glass substrate 52 and a second glass substrate 53. The first glass substrate 52 has a first surface 52b on which the optical element 5 is mounted, a second surface 52c on which the temperature control element 6 is mounted, and a via hole 52d extending from the first surface 52b to the second surface 52c. The second glass substrate 53 has a hollow space 53b, which will be described later, and is stacked on the first glass substrate 52 to form a multilayer glass substrate. The first housing 3 is arranged, for example, in the hollow space 53b and bonded to the first glass substrate 52. In this case, the second glass substrate 53 can function as a wiring layer. For example, the optical element 5 is electrically connected to the electrical wiring 43b of the circuit board 43 via the second glass substrate 53.

For example, both the first glass substrate 52 and the second glass substrate 53 are made of glass. The second glass substrate 53 is bonded to the first surface 52b of the first glass substrate 52. The second glass substrate 53 has the hollow space 53b penetrating the second glass substrate 53 in the third direction D3. The first airtight space K1 is defined by the first surface 52b of the first glass substrate 52 and the first housing 3.

The first glass substrate 52 has a first thermal pad 52f formed on the first surface 52b and bonded to the bump 7, a second thermal pad 52g formed on the second surface 52c, and an electrical wiring 52h formed on the first surface 52b and extending from the bump 7 to the outside of the first housing 3. The second glass substrate 53 has a third surface 53c facing the first surface 52b of the first glass substrate 52, a fourth surface 53d facing the side opposite to the third surface 53c, and a via hole 53f penetrating the second glass substrate 53 in the third direction D3. An electrical wiring 53h is formed on the fourth surface 53d. The electrical wiring 52h is electrically connected to the electrical wiring 53h through the via hole 53f (filled with metal). The first glass substrate 52 and the second glass substrate 53 are stacked while being adhered to each other with, for example, the adhesive. However, it is desirable that there is no adhesive between the via hole 53f and the electrical wiring 52h in order to achieve the electrical connection. The optical module 51 has an electrical terminal 54 interposed between the second glass substrate 53 and the circuit board 43. The electrical terminal 54 is formed on the fourth surface 53d. The electrical terminal 54 electrically connects the electrical wiring 53h of the second glass substrate 53 and the electrical wiring 43b of the circuit board 43 to each other. In comparison to Modified Example 2, since Modified Example 4 can also suppress a height H2a of the first housing 3 to be lower than the height H6 of the electrical terminal 54, the optical module 51 can be easily mounted without providing the cavity as illustrated in FIG. 6 to the circuit board 43. It is noted that the height H6 of the electrical terminal 54 corresponds to the distance between the fourth surface 53d of the second glass substrate 53 and the circuit board 43 in the third direction D3. In addition, the height H2a of the first housing 3 is not a distance from the first surface 52b to which the first housing 3 is connected to the surface of the first housing 3 facing the circuit board 43 (height H2 of the first housing 3 in the third direction D3), and the height H2a corresponds to the distance from the fourth surface 53d on which the electrical terminal 54 is formed to the surface of the first housing 3 facing the circuit board 43. The fourth surface 53d corresponds to the surface mounting side of the glass substrate 2 configured with the first glass substrate 52 and the second glass substrate 53. Therefore, the height H2 of the first housing 3 and the height H6 of the electrical terminal 54 are determined based on the surface mounting side. According to Modified Example 4, even when the height H2 of the first housing 3 in the third direction D3 is larger than the height H6 of the electrical terminal 54, the height H2a of the first housing 3 can be suppressed to be lower than the height H6 of the electrical terminal 54.

Next, as Modified Example 5, the example of a glass substrate 62, an optical element 65, and a temperature control element 66 in the optical module 61 mounted face-up will be described with reference to FIG. 9. FIG. 9 illustrates a perspective plan view of the glass substrate 62, the optical element 65, and the temperature control element 66 when viewed from the third direction D3 (second housing 4 side). The glass substrate 62 has a plurality of the via holes 62d arranged along the first direction D1 and arranged along the second direction D2, and thermal pads 62f and 62g. The thermal pad 62f is formed on a second surface 62c (not shown but the same as the second surface 52c) of the glass substrate 62, and the thermal pad 62g is formed on a first surface 62b (not shown but the same as the first surface 52b) of the glass substrate 62. The via holes 62d are arranged in a grid pattern. The thermal pads 62g and 62f are thermally and firmly connected through the via holes 62d. In the face-up mounted optical module 61, for example, the entire back surface of the optical element 65 is connected to the thermal pad 62g through silver paste or the like. The optical element 65 is arranged, for example, inside the thermal pad 62g. The temperature control element 66 is arranged inside the thermal pad 62f. Although the thermal pad 62f is illustrated to be larger than the thermal pad 62g in FIG. 9, the thermal pad 62f may be formed to be smaller than the thermal pad 62g. It is noted that the thermal pad 62f and the thermal pad 62g are preferably formed so as to enclose the via hole 62d.

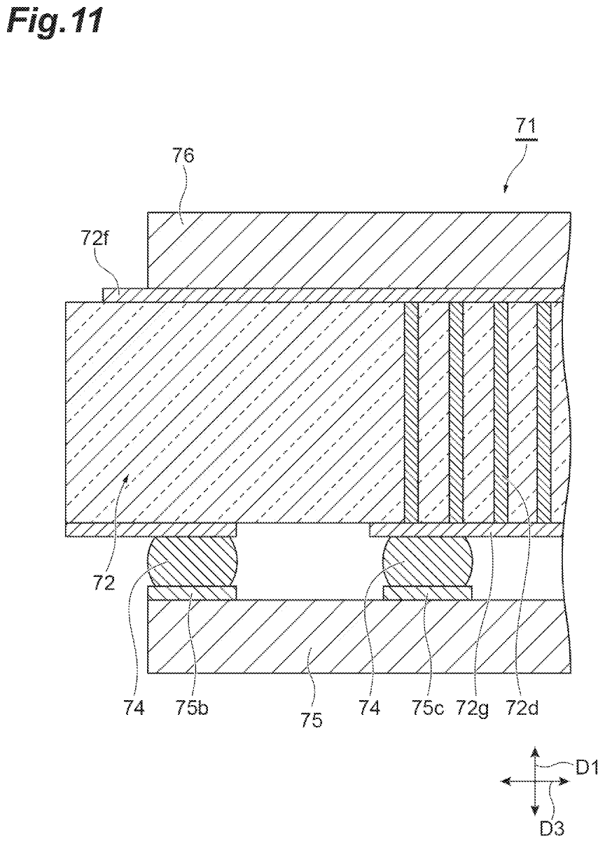

FIG. 10 is a perspective plan view illustrating a glass substrate 72, an optical element 75, and a temperature control element 76 of an optical module 71 according to Modified Example 6, and the optical module 71 is a view from the third direction D3 (second housing 4 side). FIG. 11 is a partially enlarged cross-sectional view of the glass substrate 72, the optical element 75, and the temperature control element 76 of the optical module 71. As illustrated in FIGS. 10 and 11, the glass substrate 72 has a plurality of the via holes 72d arranged in a grid pattern, a thermal pad 72g, and a thermal pad 72f. The thermal pad 72g is formed on a first surface 72b (not shown but the same as the first surface 52b) of the glass substrate 72, and the thermal pad 72f is formed on a second surface 72c (not shown but the same as the second surface 52c) of the glass substrate 72. The thermal pads 72g and 72f are thermally and firmly connected through the via hole 72d. The optical element 75 has a plurality of electrode pads 75b positioned outside the thermal pad 72g when viewed from the third direction D3, and a heat radiation pad 75c positioned inside the electrode pads 75b when viewed from the third direction D3. The thermal pad 72g is formed to be smaller than the size of the optical element 75. It is noted that the thermal pad 72f may be formed to be larger than the optical element 75. The temperature control element 76 is mounted inside the thermal pad 72f. The thermal pad 72g is connected to the heat radiation pad 75c through the electrical terminal 74.

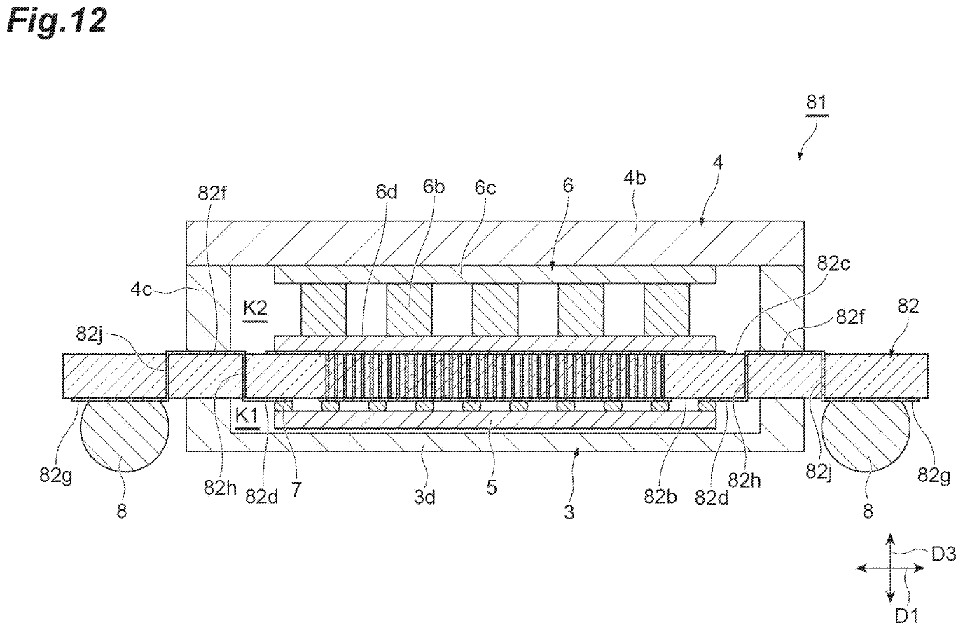

Next, an optical module 81 according to Modified Example 7 will be described with reference to FIG. 12. FIG. 12 is a cross-sectional view illustrating electrical wiring on a glass substrate 82 of the optical module 81. The glass substrate 82 has a first surface 82b on which the optical element 5 is mounted and a second surface 82c on which the temperature control element 6 is mounted and faces the opposite side of the first surface 82b. The glass substrate 82 has a first wiring 82d formed on the first surface 82b and extending from the bump 7 toward the first housing 3, a second wiring 82f formed on the second surface 82c, and a third wiring 82g formed outside the first housing 3 in the first surface 82b. When viewed from the third direction D3, the second wiring 82f extends outside the optical module 81 beyond the first wiring 82d. The second wiring 82f is, for example, in contact with the second housing 4 and extends from the inside of the second housing 4 to the outside of the second housing 4. When viewed from the third direction D3, the third wiring 82g extends outside the optical module 81 beyond the second wiring 82f. The second wiring 82f is arranged, for example, between the third wiring 82g and the first wiring 82d.

The glass substrate 82 includes a first via hole 82h penetrating the glass substrate 82 in the third direction D3 inside the first housing 3 and a second via hole 82j penetrating the glass substrate 82 in the third direction D3 outside the first housing 3. The first via hole 82h extends from the first wiring 82d to the second wiring 82f, and the second via hole 82j extends from the second wiring 82f to the third wiring 82g. The optical element 5 is electrically connected to the electrical terminal 8 through the bump 7, the first wiring 82d, the first via hole 82h, the second wiring 82f, the second via hole 82j, and the third wiring 82g. In Modified Example 7, the second wiring 82f is formed as the feedthrough wiring extending from the inside of the second airtight space K2 to the outside of the second housing 4. For this reason, it is desirable that the adhesive used for hermetic sealing of the second housing 4 and the glass substrate 2 has insulating properties. On the other hand, since there is no electrical wiring in the connecting portion between the glass substrate 82 and the first housing 3, the metal material can be used as the adhesive used for hermetically sealing the first housing 3 and the glass substrate 82. Accordingly, the airtightness of the first airtight space K1 can be enhanced, and the reliability of the optical element 5 can be improved.

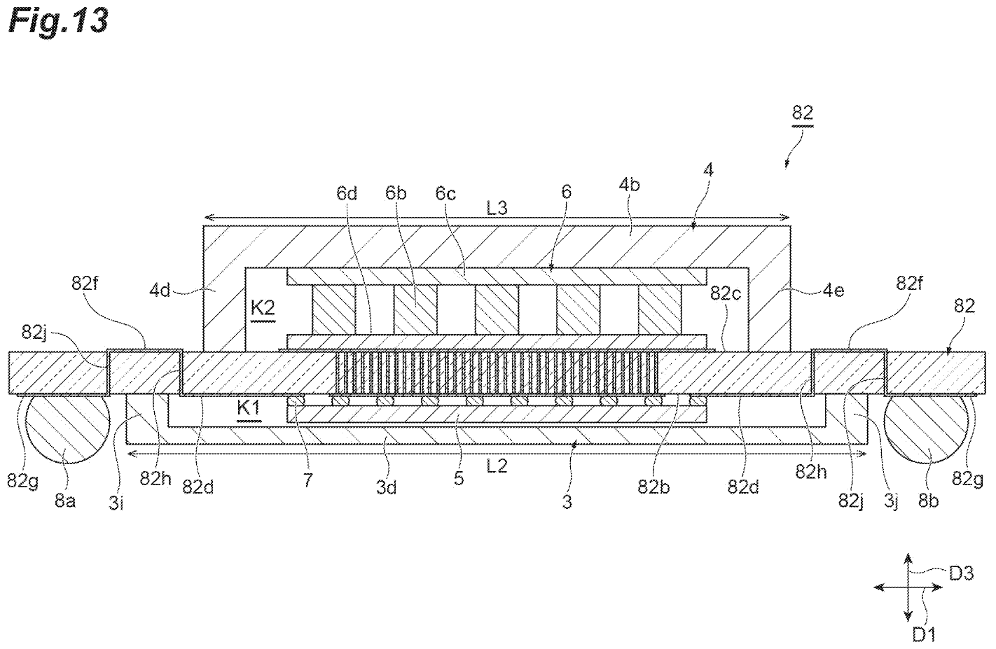

Furthermore, the modification of Modified Example 7 will be described with reference to FIG. 13. Modification illustrated in FIG. 13 differs from Modified Example 7 illustrated in FIG. 12 in that the size of the first housing 3 is larger than the size of the second housing 4. As illustrated in FIG. 13, the length L2 of the first housing 3 in the first direction D1 is set to be larger than the length L3 of the second housing 4 in the first direction D1. Further, the second housing 4 is arranged inside the first housing 3 in the first direction D1. For example, even when the lengths L2 and W2 of the first housing 3 are set to be larger than the lengths L3 and W3 of the second housing 4, the height H2 of the first housing 3 is smaller than the height H3 of the second housing 4, so that the volume of the first airtight space K1 can be allowed to be smaller than the volume of the second airtight space K2.

In the following, for the convenience of description, the electrical terminal 8 arranged on the left side in FIG. 13 is called an electrical terminal 8a, and the electrical terminal 8 arranged on the right side in FIG. 13 is called as a terminal 8b. The sidewall part 3f of the first housing 3 has a first sidewall 3i and a second sidewall 3j in the first direction D1. The first sidewall 3i is positioned closer to the electrical terminal 8a than the second sidewall 3j. In addition, the sidewall part 4c of the second housing 4 has a third sidewall 4d and a fourth sidewall 4e in the first direction D1. The third sidewall 4d is positioned closer to the electrical terminal 8a than the fourth sidewall 4e. The first sidewall 3i of the first housing 3 is arranged closer to the electrical terminal 8a than the third sidewall 4d of the second housing 4. In this configuration, by arranging the first via hole 82h inside the first housing 3 and outside the second housing 4, the first wiring 82d is formed in the first airtight space K1, and the second wiring 82f is formed outside the second airtight space K2, and thus, no feed-through wiring passing through the first sidewall 3i or the third sidewall 4d is required for any wiring.

It is noted that, when considering only the electrical wiring from the bumps 7 of the optical element 5 to the electrical terminal 8a of the glass substrate 2, the second sidewall 3j of the first housing 3 and the fourth sidewall 4e of the second housing 4 are not related to the electrical wiring, and thus, the second sidewall 3j of the first housing 3 may be positioned closer to the electrical terminal 8a than the fourth sidewall 4e of the second housing 4. Therefore, in such a case, the length L2 of the first housing 3 may not be set to be larger than the length L3 of the second housing 4. By omitting the feedthrough wiring, the airtightness of both the first airtight space K1 and the second airtight space K2 can be further improved, and the reliability of the optical element 5 and the temperature control element 6 can be further improved.

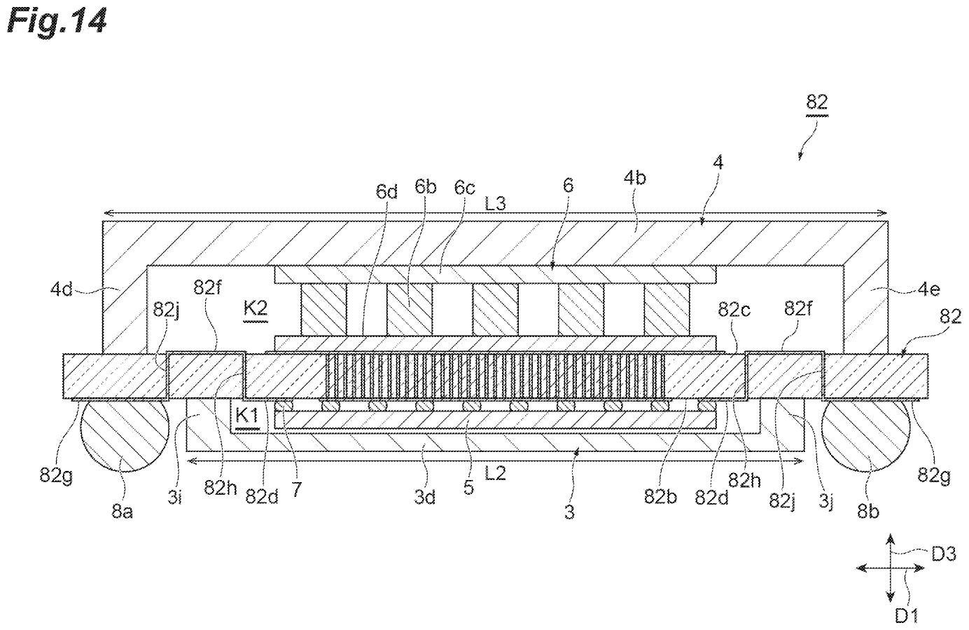

Furthermore, another modification of Modified Example 7 will be described with reference to FIG. 14. The modification of FIG. 14 differs from Modified Example 7 of FIG. 12 in that the size of the second housing 4 is larger than the size of the first housing 3. As illustrated in FIG. 14, the length L3 of the second housing 4 in the first direction D1 is set to be larger than the length L2 of the first housing 3 in the first direction D1. In addition, the first housing 3 is arranged inside the second housing 4 in the first direction D1. For example, when the lengths L2 and W2 of the first housing 3 are set to be smaller than the lengths L3 and W3 of the second housing 4, the volume of the first airtight space K1 can be allowed to be smaller than the volume of the second airtight space K2.

In the following, for the convenience of description, the electrical terminal 8 arranged on the left side in FIG. 14 is called as an electrical terminal 8a, and the electrical terminal 8 arranged on the right side in FIG. 14 is called as a terminal 8b. The sidewall part 3f of the first housing 3 has the first sidewall 3i and the second sidewall 3j in the first direction D1. The first sidewall 3i is positioned closer to the electrical terminal 8a than the second sidewall 3j. In addition, the sidewall part 4c of the second housing 4 has the third sidewall 4d and the fourth sidewall 4e in the first direction D1. The third sidewall 4d is positioned closer to the electrical terminal 8a than the fourth sidewall 4e. The third sidewall 4d of the second housing 4 is arranged closer to the electrical terminal 8a than the first sidewall 3i of the first housing 3. In this configuration, by arranging the second via hole 82j inside the second housing 4 and outside the first housing 3, the first wiring 82d is formed in the first airtight space K1, the second wiring 82f is formed in the second airtight space K2, and the third wiring 82g is formed outside the first airtight space K1, and thus, no feed-through wirings pass through the first sidewall 3i or the third sidewall 4d is required for any wiring.

It is noted that, when considering only the electrical wiring from the bumps 7 of the optical element 5 to the electrical terminal 8a of the glass substrate 2, the second sidewall 3j of the first housing 3 and the fourth sidewall 4e of the second housing 4 are not related to the electrical wiring, and thus, the fourth sidewall 4e of the second housing 4 may be positioned closer to the electrical terminal 8a than the second sidewall 3j of the first housing 3. Therefore, in such a case, the length L3 of the second housing 4 may not be set to be larger than the length L2 of the first housing 3. By omitting the feedthrough wiring, the airtightness of both the first airtight space K1 and the second airtight space K2 can be further improved, and the reliability of the optical element 5 and the temperature control element 6 can be further improved.

The embodiment and various modifications according to the present disclosure have been described above. However, the present invention is not limited to the above-described embodiments or various modifications, and can be appropriately modified within the scope of the claims. In addition, the optical module according to the present disclosure may be a combination of multiple examples of the above-described embodiments and the first to seventh modifications. For example, the configuration, shape, size, material, number, and arrangement of each component of the optical module according to the present disclosure are not limited to the above-described embodiments or modifications, and can be changed as appropriate.

What is claimed is:

1. An optical module comprising:
a glass substrate having a first surface, a second surface opposite to the first surface, and a via hole connecting the first surface and the second surface each other;
an optical element mounted on the first surface of the glass substrate and joined to the via hole of the glass substrate, the optical element being configured to consume an electricity and perform at least one of an input and an output of an optical signal;
a temperature control element mounted on the second surface of the glass substrate and joined to the via hole of the glass substrate, the temperature control element being configured to regulate a temperature of the optical element; and
a first housing attached to the first surface, the first housing being configured to hermetically seal the optical element.

2. The optical module according to claim 1,
wherein the via hole has a thermal conductivity larger than a thermal conductivity of a glass material of the glass substrate.

3. The optical module according to claim 1,
wherein the first surface of the glass substrate has an electrical terminal configured to be connected to an external circuit board for surface mounting of the optical module.

4. The optical module according to claim 1, further comprising
a second housing attached to the second surface of the glass substrate and configured to hermetically seal the temperature control element,
wherein the second housing includes a heat radiation member thermally coupled to the temperature control element for heat radiation to an outside.

5. The optical module according to claim 4,
wherein the first housing has an inner volume smaller than an inner volume of the second housing.

6. The optical module according to claim 2,
wherein the first surface of the glass substrate has an electrical terminal configured to be connected to an external circuit board for surface mounting of the optical module.

7. The optical module according to claim 2, further comprising
a second housing attached to the second surface of the glass substrate and configured to hermetically seal the temperature control element,
wherein the second housing includes a heat radiation member thermally coupled to the temperature control element for heat radiation to an outside.

8. The optical module according to claim 3, further comprising
a second housing attached to the second surface of the glass substrate and configured to hermetically seal the temperature control element,
wherein the second housing includes a heat radiation member thermally coupled to the temperature control element for heat radiation to an outside.

9. An optical module comprising:
an optical element configured to consume an electricity and perform at least one of an input and an output of an optical signal;
a temperature control element configured to regulate a temperature of the optical element; and
a glass substrate sandwiched between the optical element and the temperature control element, the glass substrate including a via hole connected between the optical element and the temperature control element, the via hole having a thermal conductivity larger than a thermal conductivity of a glass material of the glass substrate.

10. The optical module according to claim 9,
wherein the glass substrate having a first surface, a second surface opposite to the first surface, and
wherein the optical element is mounted on the first surface and the temperature control element is mounted on the second surface.

11. The optical module according to claim 10,
wherein the first surface of the glass substrate has an electrical terminal configured to be connected to an external circuit board.
